(19) United States
(12) Patent Application Publication
(10) Pub. No.: US 2013/0307941 A1
(43) Pub. Date: Nov. 21, 2013

(54) VIDEO PROCESSING DEVICE AND VIDEO PROCESSING METHOD

(71) Applicant: KABUSHIKI KAISHA TOSHIBA, Tokyo (JP)

(72) Inventor: Takahiro TAKIMOTO, Tokyo (JP)

(73) Assignee: KABUSHIKI KAISHA TOSHIBA, Tokyo (JP)

(21) Appl. No.: 13/773,436

(22) Filed: Feb. 21, 2013

(30) Foreign Application Priority Data
May 16, 2012 (JP) 2012-112439

(51) Int. Cl. H04N 13/04

(52) U.S. Cl. CPC H04N 13/0468
USPC 348/51

(57) ABSTRACT

According to one embodiment, a video processing device includes a viewer search module, a viewer position estimator, a viewing area parameter calculator, a viewing area controller. The viewer search module is configured to search a viewer using a video taken by a camera, a distance from the display to the viewer being within a search area. The viewer position estimator is configured to estimate a viewing position of the searched viewer. The viewing area parameter calculator is configured to calculate a viewing area parameter for setting a viewing area at the estimated viewing position. The viewing area controller is configured to set the viewing area based on the viewing area parameter when the stereoscopic video is displayed on the display. The search area for the stereoscopic video being displayed on the display is narrower than the search area for the stereoscopic video not being displayed on the display.

### CROSS REFERENCE TO RELATED APPLICATIONS

This application is based upon and claims the benefit of priority from the prior Japanese Patent Application No. 2012-112439, filed on May, 16, 2012, the entire contents of which are incorporated herein by reference.

### FIELD

Embodiments described herein relate generally to a video processing device and a video processing method.

### BACKGROUND

In recent years, a stereoscopic video display apparatus (so-called glasses-free autostereoscopic television) has been widely used. A viewer can see the video displayed on the glasses-free autostereoscopic television stereoscopically without using special glasses. This glasses-free autostereoscopic video display apparatus displays a plurality of images with different viewpoints. Then, the output directions of light rays of those images are controlled by, for example, a parallax barrier, a lenticular lens or the like, and guided to both eyes of the viewer. When a viewer's position is appropriate, the viewer sees different parallax images respectively with the right and left eyes, thereby recognizing the video as stereoscopic video.

However, there has been a problem with the glasses-free autostereoscopic television in that video may not be stereoscopically viewed depending on the viewer's position.

Then, the auto-tracking technique is known in which a viewer is detected by a camera photographing a front of the glasses-free stereoscopic video display and a viewing area is controlled such that the video is stereoscopically seen at the viewer's position. However, if detecting the viewer during displaying the stereoscopic video, the processing amount is too large, which may cause delay. As a result, it is likely that the viewing area is not controlled smoothly.

### BRIEF DESCRIPTION OF THE DRAWINGS

FIG. 1 is an external view of a video display apparatus 100 according to one embodiment.

FIG. 2 is a block diagram showing a schematic configuration of the video display apparatus 100.

FIGS. 3A to 3C are diagrams of a part of the liquid crystal panel 1 and the lenticular lens 2 as seen from above.

FIG. 4 is a diagram schematically showing the viewing area.

FIGS. 5A and 5B are schematic diagrams showing a search area of the viewer search module 13.

FIG. 6 is a flowchart showing an example of processing operations of the controller 10.

FIG. 7 is a block diagram showing a schematic configuration of the video display apparatus 100.

### DETAILED DESCRIPTION

In general, according to one embodiment, a video processing device for a video display apparatus having a display configured to display a stereoscopic video, includes a viewer search module, a viewer position estimator, a viewing area parameter calculator, and a viewing area controller. The viewer search module is configured to search a viewer using a video taken by a camera, a distance from the display to the viewer being within a search area. The viewer position estimator is configured to estimate a viewing position of the searched viewer. The viewing area parameter calculator is configured to calculate a viewing area parameter for setting a viewing area at the estimated viewing position. The viewing area controller is configured to set the viewing area based on the viewing area parameter when the stereoscopic video is displayed on the display. The search area for the stereoscopic video being displayed on the display is narrower than the search area for the stereoscopic video not being displayed on the display.

Embodiments will now be explained with reference to the accompanying drawings.

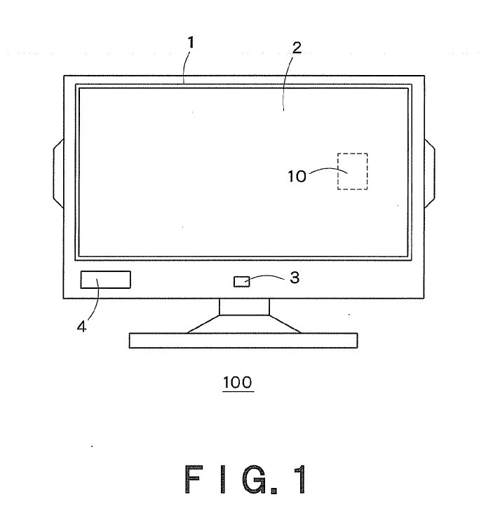

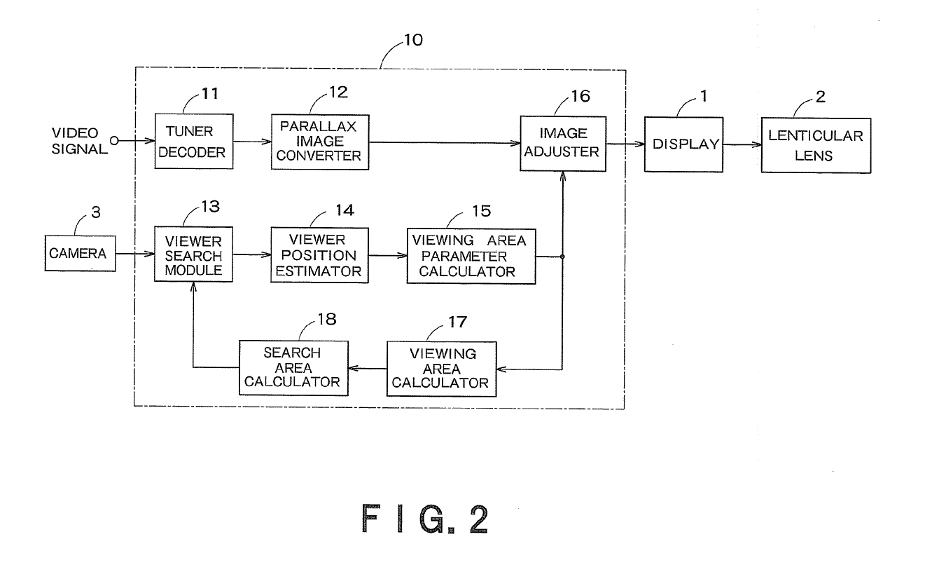

FIG. 1 is an external view of a video display apparatus 100 according to one embodiment, and FIG. 2 is a block diagram showing a schematic configuration thereof. The video display apparatus 100 has a liquid crystal panel 1, a lenticular lens 2, a camera 3, a light receiver 4 and a controller 10.

The liquid crystal panel (display unit) 1 displays a plurality of parallax images which can be observed as stereoscopic video by a viewer located in a viewing area. The liquid crystal panel 1 is, for example, a 55-inch size panel and has 4K2K (3840*2160) pixels. A lenticular lens is obliquely arranged on the liquid crystal panel 1, so that it is possible to produce an effect corresponding to a liquid crystal panel in which 11520 (=1280*9) pixels in the horizontal direction and 720 pixels in the vertical direction are arranged to stereoscopically display an image. Hereinafter, a model in which the number of pixels in the horizontal direction is extended in this way will be described. In each pixel, three sub-pixels, that is, an R sub-pixel, a G sub-pixel, and a B sub-pixel, are formed in the vertical direction. The liquid crystal panel 1 is irradiated with light from a backlight device (not shown in FIG. 1) provided on a rear surface. Each pixel transmits light with intensity according to an image signal supplied from the controller 10.

The lenticular lens (aperture controller) 2 outputs a plurality of parallax images displayed on the liquid crystal panel 1 (display unit) in a predetermined direction. The lenticular lens 2 has a plurality of convex portions arranged along the horizontal direction. The number of the convex portions is 1/9 of the number of pixels in the horizontal direction of the liquid crystal panel 1. The lenticular lens 2 is attached to a surface of the liquid crystal panel 1 so that one convex portion corresponds to 9 pixels arranged in the horizontal direction. Light passing through each pixel is outputted with directivity from near the apex of the convex portion in a specific direction.

In the description below, an example will be described in which 9 pixels are provided for each convex portion of the lenticular lens 2 and a multi-parallax manner of 9 parallaxes can be employed. In the multi-parallax manner, a first to a ninth parallax images are respectively displayed on the 9 pixels corresponding to each convex portion. The first to the ninth parallax images are images respectively obtained by viewing a subject from nine viewpoints aligned along the horizontal direction of the liquid crystal panel 1. The viewer can view video stereoscopically by viewing one parallax image among the first to the ninth parallax images with the left eye and viewing another parallax image with the right eye through the lenticular lens 2. According to the multi-parallax manner, the greater the number of parallaxes is, the lager the viewing area is. The viewing area is an area where a viewer can view video stereoscopically when the viewer views the liquid crystal panel 1 from the front of the liquid crystal panel 1.

The liquid crystal panel 1 can display a two-dimensional image by displaying the same color by 9 pixels corresponding to each convex portion.

In the present embodiment, the viewing area can be variably controlled according to a relative positional relationship between a convex portion of the lenticular lens 2 and the parallax images to be displayed, that is, how the parallax images are displayed on the 9 pixels corresponding to each convex portion. Hereinafter, the control of the viewing area will be described.

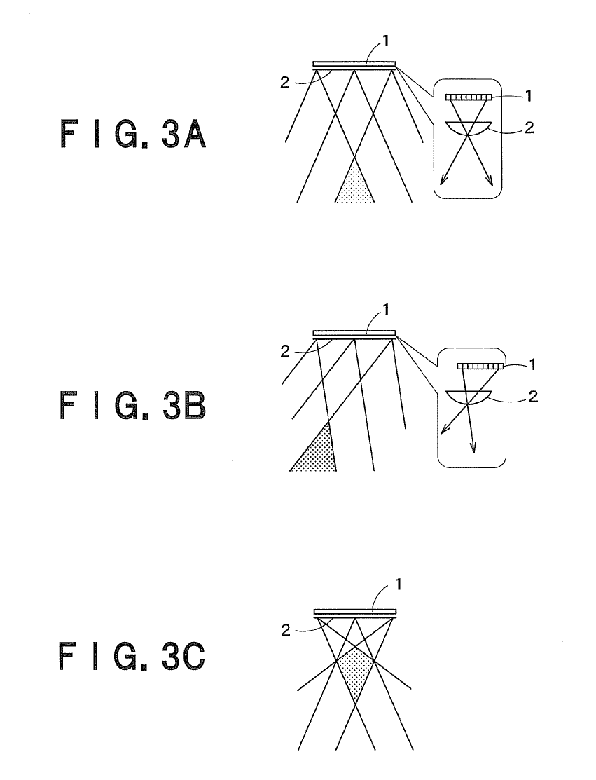

FIG. 3 is a diagram of a part of the liquid crystal panel 1 and the lenticular lens 2 as seen from above. The shaded areas in FIG. 3 indicate the viewing areas. When the liquid crystal panel 1 is viewed from a viewing area, video can be viewed stereoscopically. In other areas, reverse view and/or crosstalk occur and video is difficult to be viewed stereoscopically. The nearer to the center of the viewing area the viewer is located, the more the viewer can feel stereoscopic effect. However, even when the viewer is located in the viewing area, if the viewer is located at an edge of the viewing area, the viewer may not feel sufficient stereoscopic effect or the reverse view may occur.

FIG. 3 shows a relative positional relationship between the liquid crystal panel 1 and the lenticular lens 2, more specifically, a situation in which the viewing area varies depending on a distance between the liquid crystal panel 1 and the lenticular lens 2, or depending on the amount of shift between the liquid crystal panel 1 and the lenticular lens 2 in the horizontal direction.

In practice, the lenticular lens 2 is attached to the liquid crystal panel 1 by accurately positioning the lenticular lens 2 to the liquid crystal panel 1, and thus, it is difficult to physically change the relative positions of the liquid crystal panel 1 and the lenticular lens 2.

Therefore, in the present embodiment, display positions of the first to the ninth parallax images displayed on the pixels of the liquid crystal panel 1 are shifted, so that the relative positional relationship between the liquid crystal panel 1 and the lenticular lens 2 is changed apparently. Thereby, the viewing area is adjusted.

For example, comparing to a case in which the first to the ninth parallax images are respectively displayed on the 9 pixels corresponding to each convex portion (FIG. 3A), the viewing area moves left when the parallax images are collectively shifted right (FIG. 3B). On the other hand, when the parallax images are collectively shifted left, the viewing area moves right.

When the parallax images are not shifted near the center in the horizontal direction, and the nearer to the outer edge of the liquid crystal panel 1 the parallax images are located, the larger the parallax images are shifted outward (FIG. 3C), the viewing area moves toward the liquid crystal panel 1. A pixel between a parallax image that is shifted and a parallax image that is not shifted, and/or a pixel between parallax images that are shifted by different amounts, may be generated by interpolation according to surrounding pixels. Contrary to FIG. 3C, when the parallax images are not shifted near the center in the horizontal direction, and the nearer to the outer edge of the liquid crystal panel 1 the parallax images are located, the larger the parallax images are shifted toward the center, the viewing area moves outward from the liquid crystal panel 1.

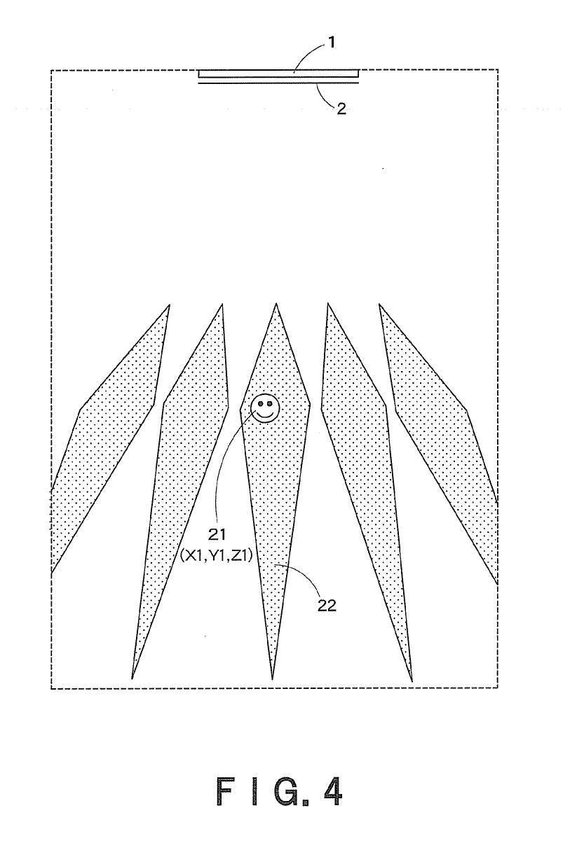

In this way, by shifting and displaying all the parallax images or a part of the parallax images, the viewing area can be moved in the left-right direction or the front-back direction with respect to the liquid crystal panel 1. Although only one viewing area is shown in FIG. 3 for the simplicity of the description, actually, there are a plurality of viewing areas in an audience area P and the viewing areas move in conjunction with each other as shown in FIG. 4. The viewing areas are controlled by the controller 10 shown in FIG. 2 described later.

Referring back to FIG. 1, the camera 3 is attached near the lower center position of the liquid crystal panel 1 at a predetermined elevation angle. The camera 3 takes video in a predetermined range in front of the liquid crystal panel 1. The taken video is supplied to the controller 10 and used to detect the position of the viewer and the face of the viewer and so on. The camera 3 may take both a moving image and a still image. Furthermore, the camera 3 can be attached at any position and any angle, and at least, the camera 3 takes the video including the viewer viewing the liquid crystal panel 1 in front of the liquid crystal panel 1.

The light receiver 4 is provided at, for example, the lower left portion of the liquid crystal panel 1. The light receiver 4 receives an infrared signal transmitted from a remote control used by the viewer. The infrared signal includes a signal indicating whether to display stereoscopic video or to display two-dimensional video, whether or not to display a menu display.

Next, the details of constituent elements of the controller 10 will be described. As shown in FIG. 2, the controller 10 includes a tuner decoder 11, a parallax image converter 12, a viewer search module 13, a viewer position estimator 14, a viewing area parameter calculator 15, an image adjuster 16, a viewing area calculator 17 and a search area calculator 18. The controller 10 is mounted as, for example, one IC (Integrated Circuit) and disposed on the rear surface of the liquid crystal panel 1. Of course, a part of the controller 10 may be implemented as software.

The tuner decoder (receiver) 11 receives and selects an inputted broadcast wave and decodes a coded input video signal. When a data broadcast signal such as electronic program guide (EPG) is superimposed on the broadcast wave, the tuner decoder 11 extracts the data broadcast signal. Or, the tuner decoder 11 receives a coded input video signal from a video output device such as an optical disk reproducing device and a personal computer instead of the broadcast wave and decodes the coded input video signal. The decoded signal is also called a baseband video signal and supplied to the parallax image converter 12. When the video display device 100 receives no broadcast wave and exclusively displays the input video signal received from the video output device, a decoder having only a decoding function may be provided instead of the tuner decoder 11 as a receiver.

The input video signal received by the tuner decoder 11 may be a two-dimensional video signal or a three-dimensional video signal including images for the left eye and the right by a frame-packing (FP) manner, a side-by-side (SBS) manner, a top-and-bottom (TAB) manner, or the like. The video signal may be a three-dimensional video signal including an image of three or more parallaxes.

The parallax image converter 12 converts the baseband video signal into a plurality of parallax image signals in order to display video stereoscopically. The process of the parallax image converter 12 depends on whether the baseband signal is a two-dimensional video signal or a three-dimensional video signal.

When a two-dimensional video signal or a three-dimensional video signal including an image of eight or less parallaxes is inputted, the parallax image converter 12 generates the first to the ninth parallax image signals on the basis of depth value of each pixel in the video signal. A depth value is a value indicating how much near-side or far-side of the liquid crystal panel 1 each pixel is seen. The depth value may be added to the input video signal in advance or the depth value may be generated by performing motion detection, composition recognition, human face detection, and the like on the basis of characteristics of the input video signal. On the other hand, when a three-dimensional video signal including an image of 9 parallaxes is inputted, the parallax image converter 12 generates the first to the ninth parallax image signals by using the video signal.

The parallax image signals of the input video signal generated in this way is supplied to the image adjuster 16.

The viewer search module 13 searches, using a video taken by the camera 3, a viewer, the distance between the viewer and the liquid crystal panel 1 being within a predetermined search area. More specifically, the viewer search module 13 searches the viewer by detecting the face of the viewer with a face dictionary stored in the controller 10. The face dictionary means information indicative of features of human faces, such as eyes, noses and mouths. By the processing of the viewer search module 13, the position (x, y) of the viewer's face in the video, a face width “w” as a parameter corresponding to the viewing distance, and so on are calculated.

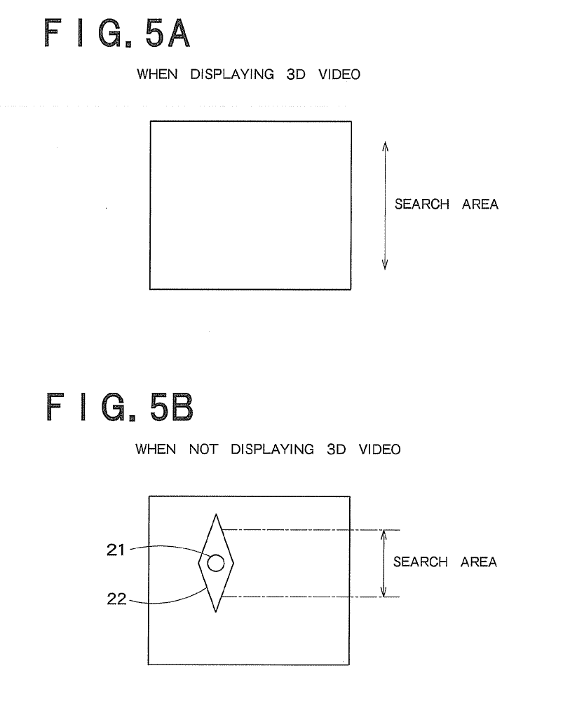

FIGS. 5A and 5B are schematic diagrams showing a search area of the viewer search module 13. When, on the liquid crystal panel 1, a stereoscopic video is not displayed and two dimensional video or the menu screen is displayed, the viewer search module 13 detect the viewer's face setting a distance with which the viewer is supposed to view the liquid crystal panel 1, or a viewing distance described in an explanatory leaflet (for example, 1.5[m] to 5.0[m]) as the search area (FIG. 5A). On the other hand, when a stereoscopic video is displayed on the liquid crystal panel 1, the search area is narrower than the above search area, for example, 2.0[m] to 4.0[m] (FIG. 5B).

When the stereoscopic video is not displayed, by setting the search area wider, it is possible to detect the viewer's position precisely and make the number of the detected humans taken by the camera 3 as many as possible. Furthermore, as described later, the search area for the stereoscopic video being displayed on the liquid crystal display 1 is calculated by the search area calculator 18 based on the position of the viewer detected when the stereoscopic video is not displayed on the display. Because of this, even if the search area is set narrow, the detection accuracy of the viewer does not decrease and the viewer who can view the stereoscopic video can be detected as long as the viewer does not move drastically.

Generally, when displaying the stereoscopic video, the processing amount of the controller 10 becomes large. Furthermore, if the processing amount of the viewer search module 13 is large, the operation speed of the controller 10 may decrease, by which the viewing area may not be appropriately controlled.

In the glasses-free autostereoscopic display, the distance with which the video can be seen stereoscopically depends on the viewing area. Therefore, if viewers at least within the viewing area can be detected, the number of the viewers who can see the video stereoscopically is constant even if the area of face search is set narrow. Then, the present embodiment decreases the processing amount of the controller 10 by setting the search area of the viewer search module 13 to be narrow when the stereoscopic video is displayed as above.

The viewer position estimator 14 estimates viewer's position information in the real space. The viewer's position information is represented as positions on X axis (horizontal direction), Y axis (vertical direction) and Z axis (direction perpendicular to the liquid crystal display 1), whose origins are on the center of the liquid crystal panel 1, for example. The viewer position estimator estimates, for example, the position on the Z axis corresponding to the viewing distance based on the calculated face width “w” and so on, and the positions on the X and Y axes based on the face position (x, y) and the known taking area of the camera 3.

Note that the manner to detect the viewer's position by the viewer search module 13 and the viewer position estimator 14 is not limited. The camera 3 may be an infrared camera, and it is also possible to detect the viewer's position using the acoustic wave.

The viewing area information calculator 15 calculates a viewing area parameter for setting a viewing area that accommodates the detected viewer by using the position information of the viewer supplied from the viewer position estimator 14. The viewing area parameter is, for example, the amount by which the parallax images are shifted as described in FIG. 3. The viewing area parameter is one parameter or a combination of a plurality of parameters. The viewing area parameter calculator 15 supplies the calculated viewing area parameter to the image adjuster 16 and the viewing area calculator 17.

The image adjuster (viewing area controller) 16 performs adjustment such as shifting and interpolating the parallax image signals according to the calculated viewing area parameter in order to control the viewing area when the stereoscopic video is displayed on the liquid crystal panel 1, and thereafter supplies the adjusted parallax image signals to the liquid crystal panel 1 to cause the liquid crystal panel 1 to display the parallax images.

The viewing area calculator 17 calculates the viewing area set according to the viewing area parameter. More specifically, the viewing area calculator 17 calculates a position closest to the liquid crystal panel 1 and a position farthest to the liquid crystal panel 1. The viewing area calculator 17 calculates the viewing area at least when the stereoscopic video is not displayed. When the stereoscopic video is displayed, the viewing area calculator may or may not calculate the viewing area.

The search area calculator 18 calculates the search area for the stereoscopic video being displayed based on the viewing area calculated when the stereoscopic video is not displayed. For example, as shown in FIG. 5B, “N” (N is a positive number equal to or below 100) % of the calculated viewing area is set as the search area. That is, at least a part of an area from the position closest to the liquid crystal panel 1 to the position farthest thereto is set as the search area.

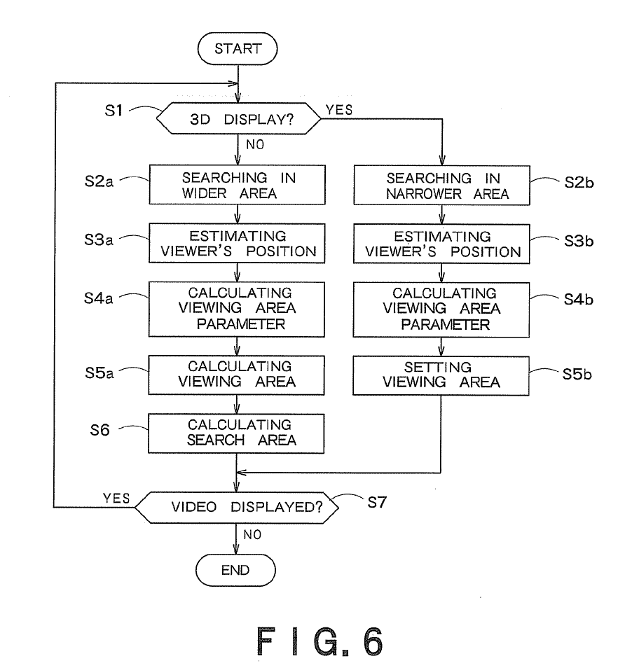

FIG. 6 is a flowchart showing an example of processing operations of the controller 10.

Firstly, the viewer search module 13 determines whether or not the stereoscopic video is displayed on the liquid crystal panel 1 (Step S1). The viewer search module 13 can determine based on a flag indicative of whether or not the parallax image converter 12 generates parallax images for displaying the stereoscopic video.

When the stereoscopic video is not displayed (Step S1-NO), the viewer search module 13 searches the viewer(s) in a wide area as shown in FIG. 5A (Step S2a). Then, the viewer position estimator 14 estimates the viewer's position in the real space (Step S3a). Furthermore, the viewing area parameter calculator 15 calculates the viewing area parameter such that the viewing area is set at the estimated viewer's position (Step 4a).

Then, the viewing area calculator 17 calculates the viewing area set according to the calculated viewing area parameter (Step S5a). Based on this viewing area, the search area calculator 18 calculates the search area for the stereoscopic video being displayed (Step S6). Note that when the stereoscopic video is not displayed, the viewing area parameter and the search area depending thereon are only calculated, and it is unnecessary to control the viewing area actually.

When the stereoscopic video is not displayed on the liquid crystal panel 1, the controller 10 repeats the above processing operations of Step S2a to S6 (Step S7).

On the other hand, when the stereoscopic video is displayed (Step S1-YES), the viewer search module 13 searches the viewer(s) in a relatively narrow area, more specifically, in the search area calculated at Step 56 as shown in FIG. 5B (Step S2b). Since it can be assumed that the viewer does not move drastically, it is possible to reduce the processing amount by setting the search area narrow.

After that, estimating the viewer's position (Step S3b) and calculating the viewing area parameter (Step S4b) are performed. Then, the image adjuster 16 adjusts the parallax images according to the viewing area parameter to set the viewing area at the viewer's position (Step S5b).

When the stereoscopic video is not displayed on the liquid crystal panel 1, the controller 10 repeats the above processing operations of Step S2b to S5b. Note that when the stereoscopic video is continued to be displayed, it is possible to continuously use the search area calculated at Step S6 or to calculate the viewing area based on the viewing area parameter calculated at Step S4b when the stereoscopic video is displayed to calculate the search area based thereon.

As stated above, in the present embodiment, when the stereoscopic video is not displayed, the viewer's position can be detected accurately by setting the search area wide. On the other hand, when the stereoscopic display is displayed, the search area is set narrow based on the detected viewer's position, thereby reducing the processing amount without decreasing the accuracy of viewer detection. As a result, the viewing area can be set smoothly.

Note that when there are a plurality of viewers, all of the viewers may be detected in order to set the viewing area at all of them, or some of the viewers may be detected according to a predetermined priority. The priority is, for example, set higher for a viewer at the front face of the display or at the recommended viewing distance (for example, three times the vertical length of the liquid crystal panel 1).

Note that, in the present embodiment, an example has been shown where the search area is controlled depending on whether or not the stereoscopic video is displayed. More generally, it is also possible to search the viewer in wider area when the load factor is low, and search the viewer in narrower area when the load factor is high. More specifically, the load factor is a usage rate of a CPU and/or a memory, for example. The search area may be controlled by comparing the usage rate with a predetermined threshold.

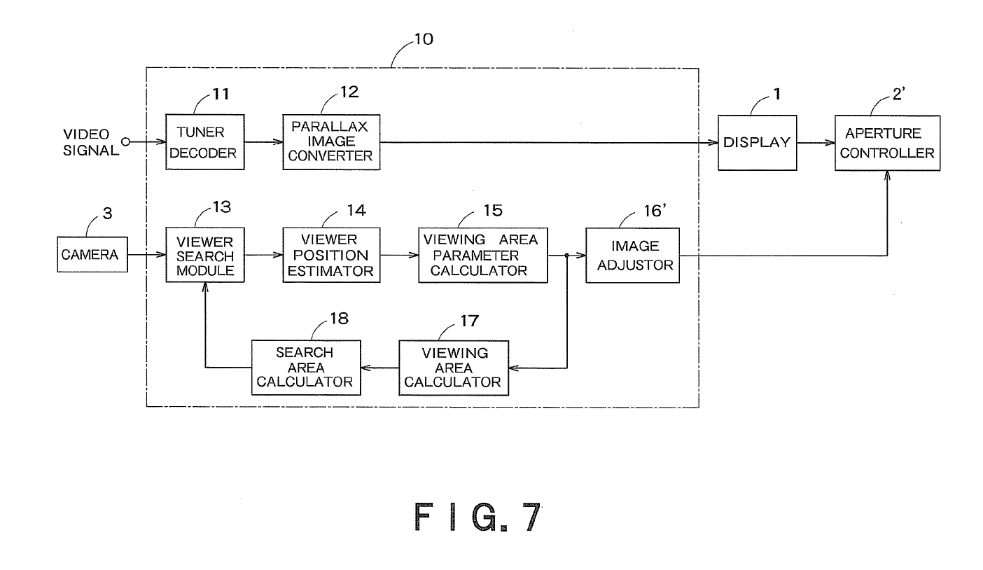

Although, in each embodiment, an example is described in which the lenticular lens 2 is used and the viewing area is controlled by shifting the parallax images, the viewing area may be controlled by other manners. For example, instead of the lenticular lens 2, a parallax barrier may be provided as an aperture controller 2′. FIG. 7 is a block diagram showing a schematic configuration of the video display device 100′ which is a modified example of the embodiments shown in FIG. 2. As shown in FIG. 7, the controller 10′ of the video display device 100′ has the viewing area controller 16′ instead of the image adjuster 16.

The viewing area controller 16′ controls the aperture controller 2′ according to the viewing area parameter calculated by the viewing area information calculator 15. In the present modified example, the viewing area parameter includes a distance between the liquid crystal panel 1 and the aperture controller 2′, the amount of shift between the liquid crystal panel 1 and the aperture controller 2′ in the horizontal direction, and the like.

In the present modified example, the output direction of the parallax images displayed on the liquid crystal panel 1 is controlled by the aperture controller 2′, so that the viewing area is controlled. In this way, the viewing area controller 16′ may control the aperture controller 2′ without performing a process for shifting the parallax images.

At least a part of the video processing system explained in the above embodiments can be formed of hardware or software. When the video processing system is partially formed of the software, it is possible to store a program implementing at least a partial function of the video processing system in a recording medium such as a flexible disc, CD-ROM, etc. and to execute the program by making a computer read the program. The recording medium is not limited to a removable medium such as a magnetic disk, optical disk, etc., and can be a fixed-type recording medium such as a hard disk device, memory, etc.

Further, a program realizing at least a partial function of the video processing system can be distributed through a communication line (including radio communication) such as the Internet etc. Furthermore, the program which is encrypted, modulated, or compressed can be distributed through a wired line or a radio link such as the Internet etc. or through the recording medium storing the program.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. A video processing device for a video display apparatus comprising a display configured to display a stereoscopic video, the video processing device comprising:
a viewer search module configured to search a viewer using a video taken by a camera, a distance from the display to the viewer being within a search area;
a viewer position estimator configured to estimate a viewing position of the searched viewer;
a viewing area parameter calculator configured to calculate a viewing area parameter for setting a viewing area at the estimated viewing position; and
a viewing area controller configured to set the viewing area based on the viewing area parameter when the stereoscopic video is displayed on the display;
wherein the search area for the stereoscopic video being displayed on the display is narrower than the search area for the stereoscopic video not being displayed on the display.

2. The device of claim 1, wherein the search area for the stereoscopic video being displayed on the display is based on the viewing position estimated when the stereoscopic video is not displayed on the display.

3. The device of claim 1 further comprising:
a viewing area calculator configured to calculate the viewing area set based on the viewing area parameter; and
a search area calculator configured to calculate the search area for the stereoscopic video being displayed on the display based on the viewing area calculated when the stereoscopic video is not displayed on the display.

4. The device of claim 3, wherein the viewing area calculator is configured to calculate a first position closest to the display in the viewing area and a second position farthest to the display in the viewing area, and
the search area calculator is configured to set at least a part of an area from the first position to the second position as the search area for the stereoscopic video being displayed on the display.

5. The device of claim 1, wherein the viewer search module is configured to search a first number of viewers in accordance with a first priority.

6. A video processing device for a video display apparatus comprising a display configured to display a stereoscopic video, the video processing device comprising:
a viewer search module configured to search a viewer using a video taken by a camera, a distance from the display to the viewer being within a search area;
a viewer position estimator configured to estimate a viewing position of the searched viewer;
a viewing area parameter calculator configured to calculate a viewing area parameter for setting a viewing area at the estimated viewing position; and
a viewing area controller configured to set the viewing area based on the viewing area parameter when the stereoscopic video is displayed on the display;
wherein the search area for a first load factor having a first value is narrower than the search area for a second load factor having a second value equal to or lower than the first value.

7. A video processing method for a video display apparatus comprising a display configured to display a stereoscopic video, the video processing method comprising:
searching a viewer using a video taken by a camera, a distance from the display to the viewer being within a search area;
estimating a viewing position of the searched viewer;
calculating a viewing area parameter for setting a viewing area at the estimated viewing position; and
setting the viewing area based on the viewing area parameter when the stereoscopic video is displayed on the display;
wherein the search area for the stereoscopic video being displayed on the display is narrower than the search area for the stereoscopic video not being displayed on the display.
